(19) United States
(12) Patent Application Publication
(10) Pub. No.: US 2015/0293628 A1
(43) Pub. Date: Oct. 15, 2015

(54) METHOD FOR DETECTING TOUCH DISPLAY PANEL

(71) Applicant: ULTRA CHIP INC., TAIPEI CITY (TW)

(72) Inventors: CHIOU-LING YEH, TAIPEI CITY (TW); SHIH-HSIN JUAN, TAIPEI CITY (TW)

(21) Appl. No.: 14/685,741

(22) Filed: Apr. 14, 2015

(30) Foreign Application Priority Data
Apr. 15, 2014 (TW) 103113710

(51) Int. Cl. G06F 3/044

(52) U.S. Cl. CPC G06F 3/044

(57) ABSTRACT

A method for detecting a touch display panel which includes a plurality of conductive lines which are composed of a plurality of data lines and driving lines is used to detect capacitance characteristics of the touch display panel. Between the data lines and ground has at least one first capacitance module, between the driving lines and ground has at least one second capacitance module, and between the data lines and the driving lines has at least one capacitance. The method includes electing one as a detection line in the conductive lines for detecting capacitance characteristic, then inputting a detection voltage wave to the detection line and inputting the detection voltage wave to the conductive lines which are cross the detection line to eliminate capacitance characteristic of the capacitance; detecting capacitance characteristic between the detection line and ground at last.

### FIELD OF THE INVENTION

The present invention is related to a method for detecting a touch display panel, and more particularly related to a method for detecting a touch display panel by using the same detection voltage waves to eliminate the unwanted capacitance characteristic.

### BACKGROUND OF THE INVENTION

Attending with rapid development of technology, super-twisted nematic (STN) liquid crystal display (LCD) and thin-film transistor (TFT) LCD have been widely used on the electronic devices such as flat panel displays, mobile phones, tablets, notebooks, personal digital assistances (PDA) and etc., to replace the traditional displays successively. In addition, because of the advance technology, a lot of touch display panels are also applied to the above mentioned electronic devices.

Touch sensitivity of the touch display panel is an important index for the electronic devices. Among the various parameters for detecting the touch display panel, the parameters related to capacitance characteristic are the most important ones, and thus in practice, the method for detecting the touch display panel detects the capacitance characteristic of the touch display panel as a conductor touching the touch display panel. However, the typical touch display panel includes a plurality of data lines and a plurality of driving lines crossing the data lines arrayed on the touch display panel, there would be equivalent capacitances, which may be composed of at least one of coupling capacitance, stray capacitance, capacitance from other functional circuits and etc., formed between the data lines and a ground, between the driving lines and the ground, between the data lines and the driving lines, between the data lines, and between the driving lines. When detecting capacitance characteristic of one of the data lines or the driving lines with respective to the ground, the influence of capacitance characteristic of other equivalent capacitances is inevitable and thus may lead to inaccuracy of detected result. Accordingly, there exists the need to improve the detecting method in present.

### BRIEF SUMMARY OF INVENTION

In view of the conventional method for detecting a touch display panel, which has the problem about inaccuracy of detected result due to the influence of the capacitance characteristic of the other equivalent capacitances, a method for detecting a touch display panel is provided in the present invention. This method is capable to eliminate the unwanted capacitance characteristics through inputting identical detection voltage waves to access the capacitance characteristic to be detected.

Based on the above mentioned object, a method for detecting a touch display panel is provided in accordance with an embodiment of the present invention. The method is utilized for detecting capacitance characteristics of the touch display panel in contact with a conductor. The touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, and at least one first capacitance between the data lines and the driving lines. The method comprises: (a) electing one of the conductive lines as a detection line for detecting capacitance characteristic; (b) inputting a detection voltage wave to the detection line and inputting the detection voltage wave to the conductive lines which cross the detection line to eliminate capacitance characteristic of the first capacitance; and (c) detecting capacitance characteristic between the detection line and the ground.

In accordance with a preferred embodiment of the present invention, wherein the driving lines, which are arrayed on the touch display panel along a second direction to cross the data lines, have a plurality of crossing nodes, and when at least one second capacitance is formed between the detection line and the crossing nodes, the step (b) further comprises a step (b0) of inputting the detection voltage wave to the crossing nodes to eliminate capacitance characteristic of the second capacitance.

Another method for detecting a touch display panel is provided in accordance with an embodiment of the present invention. The method is utilized for detecting capacitance characteristics of the touch display panel in contact with a conductor. The touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, at least one first capacitance between the data lines and the driving lines, and at least one second capacitance between the data lines. The method comprises: (a) electing one of the data lines as a detection line for detecting capacitance characteristic; (b) inputting a detection voltage wave to the detection line and inputting the detection voltage wave to the data lines adjacent to the detection line and the driving lines which cross the detection line to eliminate capacitance characteristic of the first capacitance and the second capacitance; and (c) detecting capacitance characteristic between the detection line and the ground.

Another method for detecting a touch display panel is also provided in accordance with an embodiment of the present invention. The method is utilized for detecting capacitance characteristics of the touch display panel in contact with a conductor. The touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, at least one first capacitance between the data lines and the driving lines, and at least one second capacitance between the driving lines. The method comprises: (a) electing one of the driving lines as a detection line for detecting capacitance characteristic; (b) inputting a detection voltage wave to the detection line and inputting the detection voltage wave to the driving lines adjacent to the detection line and the data lines which cross the detection line to eliminate capacitance characteristic of the first capacitance and the second capacitance; and (c) detecting capacitance characteristic between the detection line and the ground.

In accordance with a preferred embodiment of the present invention, the driving circuit is at least one of a data line driving circuit, a driving line driving circuit, and a capacitive touch sensing circuit.

By using the technology of the method for detecting a touch display panel provided in accordance with the present invention, the unwanted capacitance characteristics can be eliminated such that the sensing characteristic of the data lines and/or the driving lines can be identified. In addition, because only the step of inputting identical detection voltage waves is needed to access the accurate detected result, the method provided in the present invention is quite simple and highly applicable.

The embodiments adopted in the present invention would be further discussed by using the following paragraph and the figures for a better understanding.

### BRIEF DESCRIPTION OF THE DRAWINGS

FIG. 1 is a first schematic view of the touch display panel in accordance with a first preferred embodiment of the present invention;

FIG. 1A is a second schematic view of the touch display panel in accordance with the first preferred embodiment of the present invention;

FIG. 2 is a flow chart showing the method for detecting the touch display panel in accordance with the first preferred embodiment of the present invention;

FIG. 3 is a schematic view of the touch display panel in accordance with a second preferred embodiment of the present invention;

FIG. 4 is a flow chart showing the method for detecting the touch display panel in accordance with the second preferred embodiment of the present invention;

FIG. 5 is a schematic view of the touch display panel in accordance with a third preferred embodiment of the present invention;

FIG. 6 is a flow chart showing the method for detecting the touch display panel in accordance with the third preferred embodiment of the present invention;

FIG. 7 is a schematic view of the touch display panel in accordance with a fourth preferred embodiment of the present invention; and

FIG. 8 is a flow chart showing the method for detecting the touch display panel in accordance with the fourth preferred embodiment of the present invention;

### DETAILED DESCRIPTION OF THE INVENTION

There are various embodiments of the method for detecting a touch display panel provided in accordance with the present invention, which are not repeated hereby. Only four preferred embodiments are mentioned in the following paragraph as an example.

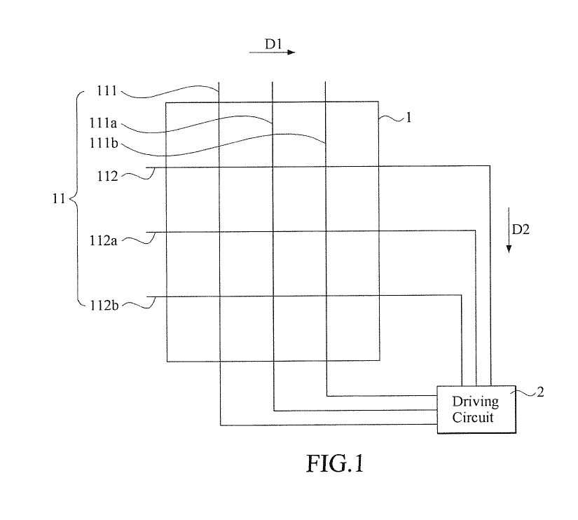

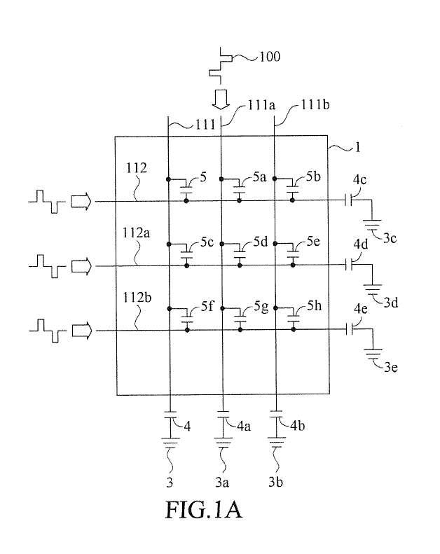

Please refer to FIG. 1 and FIG. 1A, wherein FIG. 1 is a first schematic view of the touch display panel in accordance with a first preferred embodiment of the present invention and FIG. 1A is a second schematic view of the touch display panel in accordance with the first preferred embodiment of the present invention. As shown, the method for detecting a touch display panel provided in accordance with an embodiment of the present invention is applied to a touch display panel 1, such as a STN LCD panel. The touch display panel 1 is electrically coupled to a driving circuit 2 and includes a plurality of conductive lines 11 (only one of them is labeled in the figure). These conductive lines 11 are composed of a plurality of data lines 111, 111a, 111b and a plurality of driving lines 112, 112a, 112b. These data lines 111, 111a, 111b are arrayed on the touch display panel 1 along a first direction D1 (or X direction in the figure). The driving lines 112, 112a, 112b are arrayed on the touch display panel 1 along a second direction D2 (or Y direction in the figure) so as to cross the plurality of data lines 111, 111a, 111b.

There exists one first capacitance module 4, 4a, or 4b located between the data line 111, 111a, or 111b and the corresponded ground 3, 3a, or 3b. The number of such first capacitance module can be plural in accordance with another embodiment of the present invention. There exists one second capacitance module 4c, 4d, 4e located between the driving line 112, 112a, 112b and the corresponded ground 3c, 3d, 3e. The number of such second capacitance module 4c, 4d, 4e can be plural in accordance with another embodiment of the present invention. There exists at least one first capacitance 5, 5a, 5b, 5c, 5d, 5e, 5f, 5g, 5h located between the data lines 111, 111a, 111b and the driving lines 112, 112a, 112b.

The data lines 111, 111a, 111b and the driving lines 112, 112a, 112b are well known in the art, and the other conductive lines on the touch display panel capable of conducting electrical signal are within the scope of the present invention.

The data lines 111, 111a, 111b and the driving lines 112, 112a, 112b are electrically coupled to the driving circuit 2, which can be at least one of a data line driving circuit, a driving line driving circuit, and a capacitive touch sensing circuit. For example, if the driving circuit 2 includes the data line driving circuit and the driving line driving circuit, the data lines 111, 111a, 111b and the driving lines 112, 112a, 112b are electrically coupled to the data line driving circuit and the driving line driving circuit respectively; if the driving circuit 2 is the capacitive touch sensing circuit, all the data lines 111, 111a, 111b and the driving lines 112, 112a, 112b are electrically coupled to the capacitive touch sensing circuit.

In addition, these grounds 3-3e can be a relative ground or an absolute ground, and these grounds 3-3e can be a single grounded end or a plurality of different grounded ones, which depends on the need of circuit design in practice.

It should be noted that the first capacitance module 4, 4a, 4b in the present embodiment is defined as the equivalent capacitance between the data line 111, 111a, 111b and the ground of the driving circuit 2 or of the touch display panel 1. For example, there might be self capacitance, stray capacitance, coupling capacitance or capacitance from the other functional circuits located on the electrically connection path between the data lines 111, 111a, 111b and the driving circuit 2, and the combination of at least one of the above mentioned capacitances can be equivalent to a capacitance value corresponding to the first capacitance module 4, 4a, 4b defined in the present embodiment. The definition of the second capacitance module 4c, 4d, 4e is identical to the first capacitance module 4, 4a, 4b and thus is not repeated here.

Moreover, in the present embodiment, the first capacitance 5-5h is defined as equivalent to the coupling capacitance and the stray capacitance between the data lines 111, 111a, 111b and the driving lines 112, 112a, 112b. That is, there might be coupling capacitances and stray capacitances existed between each of the data lines 111, 111a, 111b and each of the driving lines 112, 112a, 112b crossing the data lines 111, 111a, 111b, and the capacitance equivalent to the coupling capacitance and the stray capacitance is defined as the first capacitance 5-5h (the first capacitance 5 is corresponding to the data line 111 and the driving line 112, the first capacitance 5a is corresponding to the data line 111a and the driving line 112, and so on).

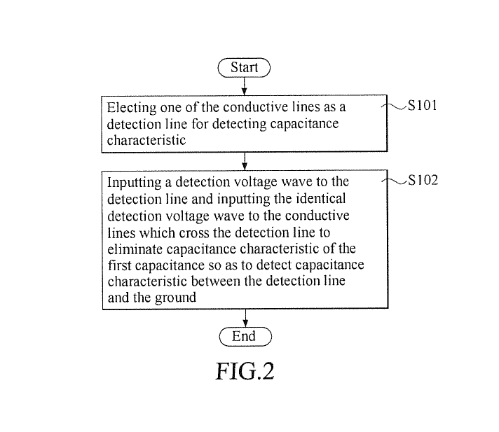

For a better understanding the present invention, please refer to FIG. 1A and FIG. 2, wherein FIG. 2 is a flow chart showing the method for detecting the touch display panel in accordance with the first preferred embodiment of the present invention. As shown, the method for detecting a touch display panel provided in accordance with the present invention is utilized for detecting capacitance characteristics of the touch display panel in contact with a conductor (not shown). The conductor can be a touch pen or a finger. The capacitance characteristics can be such as charging and discharging time of the capacitor, which can be illustrated by a waveform, and charge storage capacity. The method for detecting the touch display panel in accordance with the first preferred embodiment of the present invention comprises the steps of:

Step S101: electing one of the conductive lines as a detection line for detecting capacitance characteristic; and

Step S102: inputting a detection voltage wave to the detection line and inputting the identical detection voltage wave to the conductive lines which cross the detection line to eliminate capacitance characteristic of the first capacitance so as to detect capacitance characteristic between the detection line and the ground.

As the process begins, the step S101 is executed to elect one of the conductive lines as a detection line for detecting capacitance characteristic. When doing the detection, the touch sensing circuit (not shown) is used for electing the detection line among the conductive lines. In accordance with the first preferred embodiment of the present invention, the data line 111a is elected as the detection line for detecting capacitive characteristic of the first capacitance module 4a.

After the step S101, the step S102 is executed to input a detection voltage wave to the detection line and input the identical detection voltage wave to the conductive lines which cross the detection line to eliminate capacitance characteristic of the first capacitance so as to detect capacitance characteristic between the detection line and the ground separately. A detecting circuit, such as the touch sensing circuit, is utilized for inputting the detection voltage wave 100 to the data line 111a. The waveform of the detection voltage wave can be a periodic voltage wave or a single one. In the present embodiment, the periodic voltage wave is preferred but only one period of the wave is shown to simplify the figure. Because of the influence of capacitance characteristic of the first capacitances 5a, 5d, 5g, capacitance characteristic of the first capacitance module 4a cannot be separately detected when merely inputting the detection voltage wave to the data line 111a. Thus, in accordance with the present embodiment, the detection voltage wave is also inputted to the driving lines 112, 112a, 112b which cross the data line 111a to eliminate capacitance characteristic of the first capacitances 5a, 5d, 5g. Since the two ends of the first capacitances 5a, 5d, 5g are provided with identical voltage waves, there would be no charging and discharging effect and the capacitance characteristic of the first capacitances 5a, 5d, 5g can be eliminated.

Because the capacitance characteristic of the first capacitances 5a, 5d, 5g are eliminated, capacitance characteristic of the first capacitance module 4a between the data line 111a and the ground 3a can be detected and recorded directly by using the touch sensing circuit.

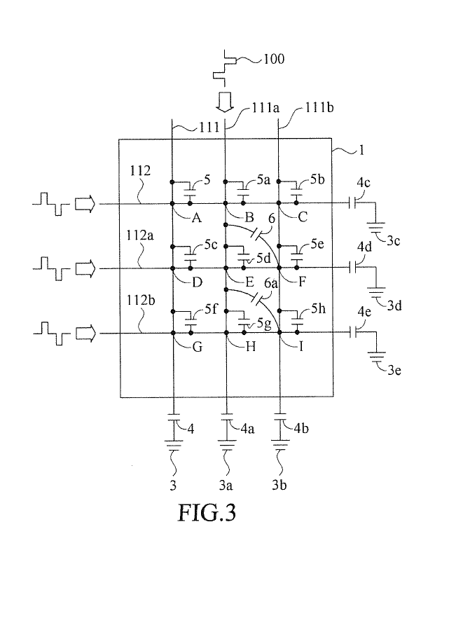

In addition, please refer to FIG. 3, which is a schematic view of the touch display panel in accordance with a second preferred embodiment of the present invention. As shown, in compared with the first preferred embodiment, the driving lines 112, 112a, 112b of the present embodiment, which are arrayed along the second direction D2 to cross the data lines 111, 111a, 111b, have a plurality of crossing nodes A, B, C, D, E, F, G, H, I, and there exist a second capacitance 6 between the data line 111a and the crossing node F and a second capacitance 6a between the data line 111 a and the crossing node I. Similar to the definition of the first capacitance 5-5h, the second capacitances 6, 6a are defined as the equivalent capacitances of the coupling capacitance and the stray capacitance between the data line 111a and the crossing node F as well as the crossing node I respectively, which is not repeated here.

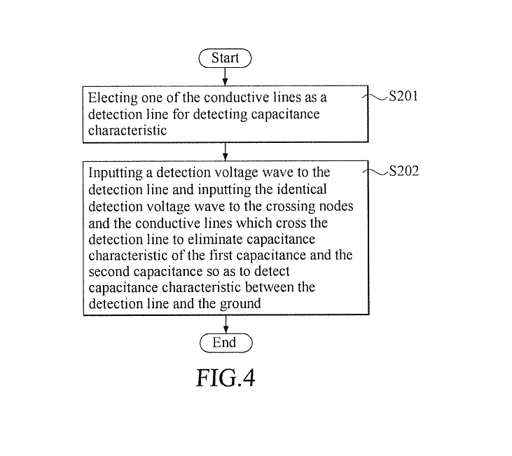

For a better understanding the present invention, please refer to both FIG. 3 and FIG. 4, wherein FIG. 4 is a flow chart showing the method for detecting the touch display panel in accordance with the second preferred embodiment of the present invention. As shown, the method for detecting a touch display panel provided in accordance with the second preferred embodiment of the present invention comprises the steps of:

Step 5201: electing one of the conductive lines as a detection line for detecting capacitance characteristic; and

Step S202: inputting a detection voltage wave to the detection line and inputting the identical detection voltage wave to the crossing nodes and the conductive lines which cross the detection line to eliminate capacitance characteristic of the first capacitance and the second capacitance so as to detect capacitance characteristic between the detection line and the ground.

As the process begins, the step S201 is executed to elect one of the conductive lines as a detection line for detecting capacitance characteristic. In accordance with the second preferred embodiment of the present invention, the data line 111a is also elected as the detection line for detecting capacitive characteristic of the first capacitance module 4a.

After the step S201, the step S202 is executed to input a detection voltage wave to the detection line and input the identical detection voltage wave to the crossing nodes and the conductive lines which cross the detection line to eliminate capacitance characteristics of the first capacitance and the second capacitance so as to detect capacitance characteristic between the detection line and the ground separately. Because of the influence of capacitance characteristics of the first capacitances 5a, 5d, 5g and the second capacitances 6, 6a, capacitance characteristic of the first capacitance module 4a cannot be separately detected when merely inputting the detection voltage wave 100 to the data line 111a. Thus, in accordance with the present embodiment, the detection voltage wave 100 is also inputted to the driving lines 112, 112a, 112b which cross the data line 111a and the crossing nodes F, Ito eliminate capacitance characteristic of the first capacitances 5a, 5d, 5g and the second capacitances 6, 6a. Since the two ends of the first capacitances 5a, 5d, 5g and the second capacitances 6, 6a are provided with identical voltage waves, there would be no charging and discharging effect and the capacitance characteristic of the first capacitances 5a, 5d, 5g and the second capacitances 6, 6a can be eliminated.

Because the capacitance characteristic of the first capacitances 5a, 5d, 5g and the second capacitances 6, 6a are eliminated, capacitance characteristic of the first capacitance module 4a between the data line 111a and the ground 3a can be detected directly by using the touch sensing circuit.

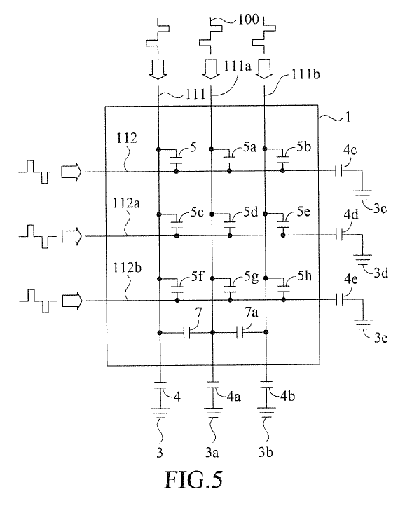

In addition, please refer to FIG. 5, which is a schematic view of the touch display panel in accordance with a third preferred embodiment of the present invention. As shown, in compared with the first preferred embodiment, the present embodiment has a third capacitance 7 between the data line 111 and data line 111a and a third capacitance 7a between the data line 111a and the data line 111b. Similar to the definition of the first capacitance 5-5h, the third capacitances 7, 7a are defined as the equivalent capacitances of the coupling capacitance and the stray capacitance between the data line 111 and the data line 111a as well as the data line 111a and the data line 111b respectively. The other portion of the present embodiment is identical to the first preferred embodiment and thus is not repeated here.

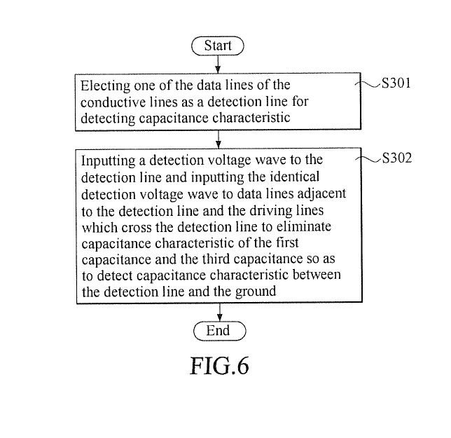

For a better understanding the present invention, please refer to both FIG. 5 and FIG. 6, wherein FIG. 6 is a flow chart showing the method for detecting the touch display panel in accordance with the third preferred embodiment of the present invention. As shown, the method for detecting a touch display panel provided in accordance with the third preferred embodiment of the present invention comprises the steps of:

Step S301: electing one of the data lines of the conductive lines as a detection line for detecting capacitance characteristic; and

Step S302: inputting a detection voltage wave to the detection line and inputting the identical detection voltage wave to data lines adjacent to the detection line and the driving lines which cross the detection line to eliminate capacitance characteristic of the first capacitance and the third capacitance so as to detect capacitance characteristic between the detection line and the ground.

As the process begins, the step S301 is executed to elect one of the data lines of the conductive lines as a detection line for detecting capacitance characteristic. In accordance with the third preferred embodiment of the present invention, the data line 111a is elected as the detection line for detecting capacitive characteristic of the first capacitance module 4a.

After the step S301, the step S302 is executed to input a detection voltage wave to the detection line and input the identical detection voltage wave to the data lines adjacent to the detection line and the driving lines which cross the detection line to eliminate capacitance characteristic of the first capacitance and the third capacitance so as to detect capacitance characteristic between the detection line and the ground separately. Because of the influence of capacitance characteristic of the first capacitances 5a, 5d, 5g and the third capacitances 7, 7a, capacitance characteristic of the first capacitance module 4a cannot be separately detected when merely inputting the detection voltage wave 100 to the data line 111a. Thus, in accordance with the present embodiment, the detection voltage wave 100 is also inputted to the driving lines 112, 112a, 112b which cross the data line 111a and the data lines 111, 111b adjacent to the data line 111a to eliminate capacitance characteristic of the first capacitances 5a, 5d, 5g and the third capacitances 7, 7a.

Because the capacitance characteristic of the first capacitances 5a, 5d, 5g and the third capacitances 7, 7a are eliminated, capacitance characteristic of the first capacitance module 4a between the data line 111a and the ground 3a can be detected directly by using the touch sensing circuit.

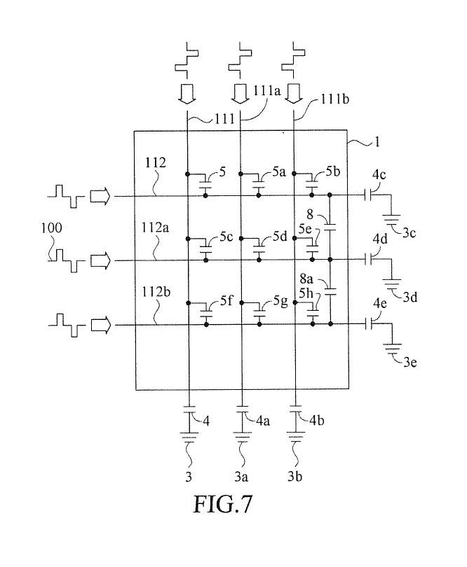

In addition, please refer to FIG. 7, which is a schematic view of the touch display panel in accordance with a fourth preferred embodiment of the present invention. As shown, in compared with the first preferred embodiment, the present embodiment has a fourth capacitance 8 between the driving line 112 and driving line 112a and a fourth capacitance 8a between the driving line 112a and the driving line 112b. Similar to the definition of the first capacitance 5-5h, the fourth capacitances 8, 8a are defined as the equivalent capacitances of coupling capacitance and stray capacitance between the driving line 112 and the driving line 112a as well as the driving line 112a and the driving line 112b respectively. The other portion of the present embodiment is identical to the first preferred embodiment and thus is not repeated here.

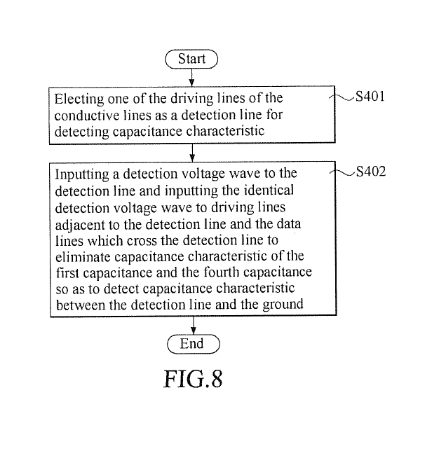

For a better understanding the present invention, please refer to both FIG. 7 and FIG. 8, wherein FIG. 8 is a flow chart showing the method for detecting the touch display panel in accordance with the fourth preferred embodiment of the present invention. As shown, the method for detecting a touch display panel provided in accordance with the fourth preferred embodiment of the present invention comprises the steps of:

Step S401: electing one of the driving lines of the conductive lines as a detection line for detecting capacitance characteristic; and

Step S402: inputting a detection voltage wave to the detection line and inputting the identical detection voltage wave to driving lines adjacent to the detection line and the data lines which cross the detection line to eliminate capacitance characteristic of the first capacitance and the fourth capacitance so as to detect capacitance characteristic between the detection line and the ground.

As the process begins, the step S401 is executed to elect one of the driving lines of the conductive lines as a detection line for detecting capacitance characteristic. In accordance with the fourth preferred embodiment of the present invention, the driving line 112a is elected as the detection line for detecting capacitive characteristic of the second capacitance module 4d.

After the step S401, the step S402 is executed to input a detection voltage wave to the detection line and input the identical detection voltage wave to the driving lines adjacent to the detection line and the data lines which cross the detection line to eliminate capacitance characteristic of the first capacitance and the fourth capacitance so as to detect capacitance characteristic between the detection line and the ground separately. Because of the influence of capacitance characteristic of the first capacitances 5c, 5d, 5e and the fourth capacitances 8, 8a, capacitance characteristic of the second capacitance module 4d cannot be separately detected when merely inputting the detection voltage wave 100 to the driving line 112a. Thus, in accordance with the present embodiment, the detection voltage wave 100 is also inputted to the data lines 111, 111a, 111b which cross the driving line 112a and the driving lines 112, 112b adjacent to the driving line 112a to eliminate capacitance characteristic of the first capacitances 5c, 5d, 5e and the fourth capacitances 8, 8a.

Because the capacitance characteristic of the first capacitances 5c, 5d, 5e and the fourth capacitances 8, 8a are eliminated, capacitance characteristic of the second capacitance module 4d between the data line 112a and the ground 3d can be detected directly by using the touch sensing circuit.

In conclusion, by using the technology of the method for detecting a touch display panel provided in accordance with the present invention, the unwanted capacitance characteristics can be eliminated such that the desired capacitance characteristic of the data lines and/or the driving lines can be identified. In addition, because only the step of inputting identical detection voltage waves is needed to access the accurate detected result, the method provided in the present invention is quite simple and highly applicable in practice.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A method for detecting a touch display panel by detecting capacitance characteristics of the touch display panel, wherein the touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, and at least one first capacitance between the data lines and the driving lines, and the method comprising:
(a) electing one of the conductive lines as a detection line for detecting capacitance characteristic; and
(b) inputting a detection voltage wave to the detection line and inputting the detection voltage wave to the conductive lines which cross the detection line to eliminate capacitance characteristic of the first capacitance so as to detect capacitance characteristic between the detection line and the ground.

2. The method for detecting a touch display panel of claim 1, wherein the driving circuit is at least one of a data line driving circuit, a driving line driving circuit, and a capacitive touch sensing circuit.

3. The method for detecting a touch display panel of claim 1, wherein the driving lines, which are arrayed on the touch display panel along a second direction to cross the data lines, have a plurality of crossing nodes, and when at least one second capacitance is formed between the detection line and the crossing nodes, and the step (b) further comprises a step (b0) of inputting the detection voltage wave to the crossing nodes to eliminate capacitance characteristic of the second capacitance.

4. A method for detecting a touch display panel by detecting capacitance characteristics of the touch display panel, wherein the touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, at least one first capacitance between the data lines and the driving lines, and at least one second capacitance between the data lines, and the method comprising:
(a) electing one of the data lines as a detection line for detecting capacitance characteristic; and
(b) inputting a detection voltage wave to the detection line and inputting the detection voltage wave to the data lines adjacent to the detection line and the driving lines which cross the detection line to eliminate capacitance characteristic of the first capacitance and the second capacitance so as to detect capacitance characteristic between the detection line and the ground.

5. The method for detecting a touch display panel of claim 4, wherein the driving circuit is at least one of a data line driving circuit, a driving line driving circuit, and a capacitive touch sensing circuit.

6. A method for detecting a touch display panel by detecting capacitance characteristics of the touch display panel, wherein the touch display panel is electrically coupled to a driving circuit and includes a plurality of conductive lines which are composed of a plurality of data lines arrayed on the touch display panel along a first direction and a plurality of driving lines arrayed on the touch display panel along a second direction to cross the plurality of data lines with at least one first capacitance module between the data lines and a ground, at least one second capacitance module between the driving lines and the ground, at least one first capacitance between the data lines and the driving lines, and at least one second capacitance between the driving lines, and the method comprising:
(a) electing one of the driving lines as a detection line for detecting capacitance characteristic; and
(b) inputting a detection voltage wave to the detection line and inputting the detection voltage wave to the driving lines adjacent to the detection line and the data lines which cross the detection line to eliminate capacitance characteristic of the first capacitance and the second capacitance so as to detect capacitance characteristic between the detection line and the ground.

7. The method for detecting a touch display panel of claim 6, wherein the driving circuit is at least one of a data line driving circuit, a driving line driving circuit, and a capacitive touch sensing circuit.
